(19) United States
(12) Patent Application Publication
(10) Pub. No.: US 2014/0359337 A1
(43) Pub. Date: Dec. 4, 2014

(54) CIRCUITS FOR LOAD POWER THRESHOLD

(71) Applicant: HEWLETT-PACKARD DEVELOPMENT COMPANY, L.P., Houston, TX (US)

(72) Inventors: Szu Tao Tong, Taipei (TW); Chien-Hao Lu, Taipei (TW); Nam Nguyen, Houston, TX (US); Robert S. Wright, Spring, TX (US)

(21) Appl. No.: 13/905,884

(22) Filed: May 30, 2013

(51) Int. Cl. G06F 1/26

(52) U.S. Cl. CPC G06F 1/266
USPC 713/340

(57) ABSTRACT

Circuits for preventing power drawn by a load from exceeding a threshold are provided. A first circuit monitors power supplied to the load and disables a power supply if a threshold is exceeded. A second circuit disconnects the load from the power supply if the threshold is exceeded.

### BACKGROUND

Typical computers today provide external ports through which peripheral equipment may be connected to the computer. One common example of such a port is a Universal Serial Bus (USB) port. The port may be used to allow the computer to send information to and receive information from the peripheral equipment. In addition to allowing the computer and peripheral to communicate information, the port may also provide power for the peripheral device. By supplying power through the port, the peripheral device does not need to have its own source of power. For example, a USB device, such as a webcam, may receive power from the computer through the USB port, without requiring a separate connection to a power source.

One example of a type of computer which may supply power to a peripheral device through a port that is also used for information communication is a Retail Point of Sale (RPOS) computer. A RPOS computer may include a number of peripheral devices, such as customer facing displays, a credit card reader, bar code readers, printers (such as receipt printers), electronic advertising signage, a physical cash drawer, and any number of other peripherals. Each of these peripherals may require power to operate. By providing power through the port that connects the peripheral to the RPOS computer, external power sources, such as power bricks, are no longer needed.

### BRIEF DESCRIPTION OF THE DRAWINGS

FIG. 1 is an example of a high level block diagram of system to ensure load power remains below a threshold, according to techniques described herein.

FIG. 2 is an example of a Retail Point of Sale (RPOS) system which may utilize the circuits described herein.

FIG. 3 is a schematic of an example implementation of circuits to implement the techniques described herein.

FIG. 4 is a example high level flow diagram according to the load power threshold techniques described herein.

### DETAILED DESCRIPTION

Supplying power to a piece of peripheral component through the same port that connects the peripheral equipment to a computer may lead to improved operation and cost effectiveness of a system. The peripheral equipment no longer needs an independent connection to a power source, thus reducing the number of cables, adaptors, power bricks, etc. needed. Furthermore, the installation of the peripheral equipment is simplified because no additional connections for power are needed. In addition, the design of the peripheral component itself may be simplified because the peripheral is able to receive power through the port, without requiring additional onboard components to regulate and condition an independent power source. In other words, the peripheral is able to be designed with the assumption that the power needed by the peripheral is being supplied by the port.

There are many examples of ports that may be used to provide power to peripheral equipment. One common type of such a port is a Universal Serial Bus (USB) port. The USB specification provides for power at +5 volts for use by peripheral equipment. The USB specification provides for the maximum amount of current that may be drawn from a USB port and USB devices are expected to comply with the specification. Certain peripheral devices, such as those used in a RPOS system, may require more power than is specified by the USB specification and may also operate at higher voltages, such as 24 volts. To accommodate this need, the Powered USB (PUSB) extension to the USB specification has been developed. The PUSB extension adds support for additional pins within a modified USB port, with those pins supplying power at 12 or 24 volts.

Although the addition of power to USB ports simplifies cabling and peripheral design, there are some additional problems that are created. One problem that arises is that a PUSB port can only supply a finite amount of power. A peripheral device attempting to consume more power than is available from the power supply providing power to the port may produce undesirable results. For example, damage to the power supply may occur if too much power is drawn by a port. One mechanism used for overcoming this problem is to include documentation with the computer system including the powered USB port indicating the maximum amount of power that may be safely drawn from the port.

Unfortunately, there is no way to force users of the computer to read, understand, and comply with the instructions provided in product documentation. Even if the documentation instructs the user to not connect a peripheral that draws more than a given amount of power, nothing can prevent the user from ignoring this admonition. Further exacerbating the problem is the fact that a peripheral device may malfunction in such a manner as to cause the device to draw more current than expected. For example, a device may have been designed to draw an acceptable amount of power from the powered USB port, however due to a failure in the device (such as a short circuit), the device may attempt to draw more power than is allowed. In such a case, the user following the written documentation is of little or no use.

In order to overcome the problems described above, safety standards organizations have developed standards and specifications to specify the amount of power that a powered port may supply under all possible conditions. If a computer with a powered USB port is compliant with the safety standards, then it can be ensured that the powered USB port in a computer compliant with the standard will never provide more power than is allowed by the standard, regardless of the peripherals connected or any faults within the peripherals.

One such safety standards organization is the United Laboratories™ (UL). Among other functions, the UL publishes standards for what are referred to as Limited Power Sources (LPS). A powered USB port may be classified as a LPS. A powered USB port that is compliant with the UL LPS standards can be ensured to not provide more power than is specified by the standard. It should be noted that the UL LPS is not restricted to power USB ports and neither are the circuits and techniques described herein. The techniques described are applicable for any type of powered port, including powered USB, Powered Serial Ports, Powered Ethernet, or any other type of port that may supply power to a peripheral.

For example, the UL has provided LPS requirement UL60950-1 ed.2. This particular requirement specifies the amount of power that may be provided by any port that certifies that it is compliant with the specification. The specification does not mandate any particular voltages or currents, but rather is more general, providing ranges for compliance, given any particular combination of voltages and currents.

UL60950-1 ed.2 specifies that a compliant LPS limits the power supplied in one of four possible ways. In other words, a compliant LPS will meet at least one of the four possible mechanisms for compliance. To paraphrase the UL60950-1 ed.2 specification, a limited power source shall comply with one of a), b), c), or d).

a) the output is inherently limited in compliance with table 2B (not shown); or

b) a linear or non-linear impendence limits the output in compliance with table 2B (not shown) If a positive temperature coefficient device is used, it shall be compliant with certain clauses of the IEC (specific clauses not shown); or

c) a regulating network limits the output in compliance with table 2B (not shown) both with and without a simulated single fault in the regulating network (open circuit or short circuit); or

d) an over current protective device is used and the output is limited in compliance with table 2C (not shown). If option d) is used, the device shall be a fuse or non-adjustable, non-autoreset, electromechanical device.

For purposes of ease of description, Tables 2B and 2C from the UL specification have been omitted. However, in general, these tables list a variety of voltage ranges, both AC and DC, and a variety of currents, and the corresponding maximum allowable power that may be provided. In addition, the tables specify the response time for each of these mechanisms. For simplicity of explanation, the values in the tables are described assuming a 24 Volt supply, as may be provided by a Powered USB port. However, it should be understood that the techniques described herein are not so limited.

Table 2B specifies that for a DC voltage that is less than 30 Volts (V), the output current is to be less than 8 Amperes (A). In addition, the apparent power is to be less than 100 Volt-Amperes (VA). In terms of a 24 Volt DC supply, this means that the allowable current is up to 4.16 A, resulting in an apparent power of 100 VA. In addition, Table 2B specifies a response time of less than 5 seconds (s) for an electronic device or circuit and 60 s otherwise. Table 2C specifies that for a DC voltage between 20V and 30V, the apparent power is to be less than 250 VA. The current allowed is to be less than 100 A divided by the voltage. In terms of a 24 V DC supply, this means that the allowable current is 4.16 A. The response time is specified as less than 120 s.

A problem with the UL specifications is that they are defined in terms of the allowable output without regard for product design considerations, actual operating voltages, and currently available components. For example, to meet item a) above, a transformer that inherently limits the output power available may be used. However, at 24V DC, the power efficiency of such a transformer is insufficiently low. This may cause thermal problems within the computer, as the inefficiency is manifested in the form of heat. The additional heat may require additional cooling, which in turn complicates the design of the computer. Thus, a transformer based solution may be unacceptable from a product design perspective.

To meet item b), a linear or non-linear device that limits the output may be used, provided that if a positive temperature coefficient device is used, it is compliant with certain aspects of the IEC. Although such devices may be available at lower voltages, no such device can be found when operating at 24V. Thus, it is not possible to meet item b) when operating at 24 V DC. Item c) specifies that a regulating network may be used to limit the output current, provided that the regulating network is capable of operation given any single fault. A short circuit (a single fault) across the regulating network between the power supply and the load would render a current regulating network incapable of regulating the current provided by the power supply.

To meet item d), a fuse or a non-adjustable, non-autoreset electromechanical device may be used. However, such a device may not be suitable from a product design/serviceability aspect. For example, if a fuse were to be used, and sufficient power were to be drawn to cause the fuse to activate, and thus disconnect the load from the power supply, the powered USB port would be unusable until the fuse was replaced. Even if a fuse is not used, item d) specifies that the device is not to be of an auto-reset type, meaning that a user may need to manually reset the device. Given that operators of a RPOS may not be technically sophisticated, replacing a fuse or manually resetting a circuit breaker may be beyond the skill level of the typical operator, thus leading to increased maintenance costs when a fuse has blown or breaker has tripped. Such increased costs may not be acceptable from a product design perspective.

To overcome these problems, techniques described herein provide a two level approach to meeting the specifications of UL60950-1 ed.2. The first level monitors the current drawn by a load to ensure that the total output power is within the limits defined by Table 2B, in compliance with item c). If those limits are exceeded, the current sensing network shuts down the power supply until output power is below the threshold value. Thus, in normal operation, there is no need for operator intervention in the case that a peripheral device is drawing too much power. If there is a single fault in the current sensing network (such as a short circuit across the sensing element which renders the sensing network inoperable) the second level of protection, compliant with item d) comes into play. In the second level of protection, a fuse may be used that disconnects the load if the allowed power output is exceeded. It should be noted that the system may continue to operate normally even when the first level of protection fails, because unless the load draws more than the allowable amount of power, the fuse will not blow. A properly operating peripheral device that is compliant with the LPS specifications for power consumption should not draw more power than is allowed.

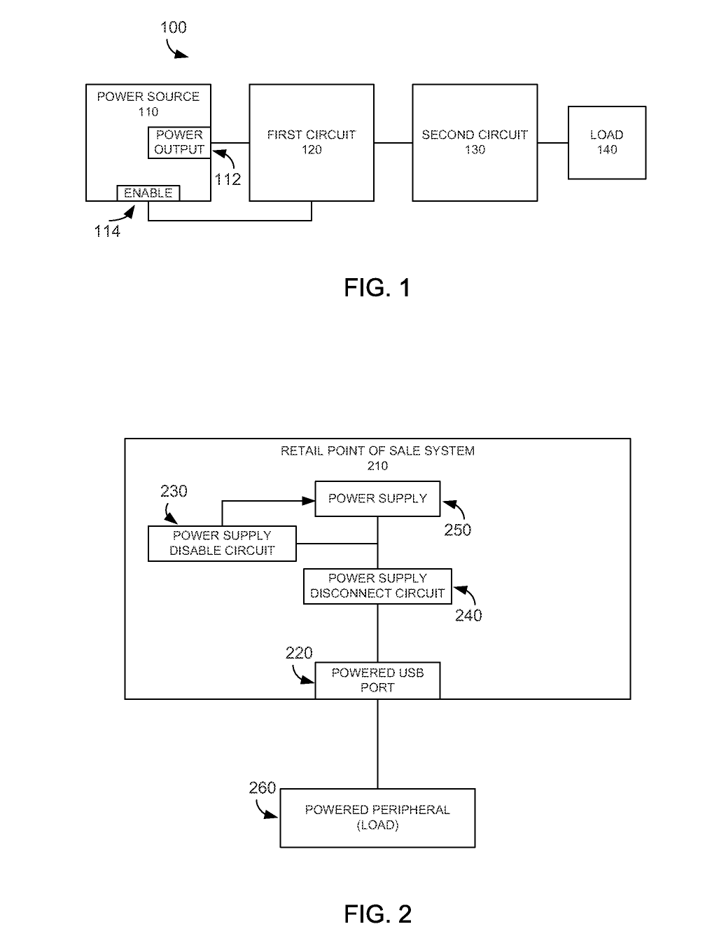

FIG. 1 is an example of a high level block diagram of system to ensure load power remains below a threshold, according to techniques described herein. System 100 may include a power source 110, a first circuit 120, a second circuit 130, and a load 140. The power source may include a power output 112 that supplies power to be used by the load. In addition, the power source may include an enable input 114. While the enable input is asserted, the power source may provide power to the power output. Conversely, when the enable input is not asserted, the power source may be prevented from providing power to the power output. In other words, the enable input may act as an on/off switch for the power source.

The first circuit 120 may be coupled to the power output 112 of the power source 110. The first circuit may be a current sensing network that may measure the current drawn by the load. The first circuit may assert the enable input 114 of the power source 110 while the current drawn is less than a threshold. The first circuit may have a first response time. For example, the first response time may be less than 5 s. The response time may indicate the time needed for the first circuit to measure that the current drawn by the load has exceeded the threshold and to de-assert the enable input of the power source. In other words, a load drawing current above the threshold may cause the first circuit to disable the power source within a time period specified by the first response time. Although a current sensing network has been mentioned, it should be understood that any circuit able to comply with item a) of the UL specification described above may be suitable.

The second circuit 130 may be coupled to the load and the power source. The second circuit may disconnect the load from the power source when the current exceeds the threshold. For example, the second circuit may be a non-resettable fuse that breaks when the output current exceeds the threshold. The second circuit may have a second response time. For example, the second response time may be 60 seconds. The response time may indicate the time needed to detect an over current condition and cause the load to be disconnected from the power source. Although a fuse has been mentioned, it should be understood that any component or group of components that form a circuit compliant with item d) of the UL specification may be suitable. Furthermore, although specific response times have been mentioned, it should be understood that the techniques described herein are not dependent on any specific value for the response time. Any response times are suitable, so long as the first response time is less than the second response time.

The load 140 may be any device that draws power from the power source. For example, the load may be a peripheral device connected to a powered USB port. Examples of peripheral devices have been described above, however the techniques described herein are applicable to any type of load, not just those previously mentioned. One example of a load may be any device that draws power at 24 V DC.

In operation, power source 110 may provide power to load 140. The first circuit 120 may be coupled to the power source to measure the current being drawn by the load. As long as the current drawn is below the threshold, the first circuit continues to assert the enable input 114 of the power source, causing the power source to continue supplying power to the load. If the current drawn by the load exceeds a threshold, the first circuit de-asserts the enable input of the power source, thus preventing the current drawn by the load from exceeding the threshold. De-asserting of the enable input may occur within a first response time.

If for some reason, the first circuit should fail in such a manner as to leave the enable input of the power source asserted, the second circuit provides a second level of protection. As long as the load does not draw more current than the threshold, the system will operate just as if the first circuit had not failed. However, if the load should begin to draw current in excess of the threshold, the second circuit may disconnect the load from the power source.

Furthermore it should be understood that the response time of the first circuit is less than that of the second circuit. Thus, in the case where the first circuit has not failed, and an over current condition exists, the first circuit may shut down the power source before the second circuit detects the over current condition and causes the load to be disconnected. Thus, in normal operation of the first circuit, an over current condition is not allowed to persist for a long enough time for the second circuit to activate. The second circuit activates in the presence of both a failure of the first circuit and a load drawing current in excess of the threshold. If both conditions do not occur, the second circuit may be dormant, and the system may continue to operate as normal, so long as the current drawn by the load remains below the threshold.

FIG. 2 is an example of a Retail Point of Sale (RPOS) system which may utilize the circuits described herein. The RPOS system 210 may include a powered USB port 220, a first circuit, which may be a power supply disable circuit 230, a second circuit, which may be a power supply disconnect circuit 240, a power supply 250, and a load, which may be a powered peripheral 260. The power supply may be a power supply that is to provide power to the powered peripheral. In one example implementation, the power supply may supply power at 24 V DC. As mentioned above, RPOS systems may include any number of powered peripherals, and the specific function of the peripheral is relatively unimportant.

The power supply disable circuit 230 may be coupled to the powered USB port 220 in such a manner as to allow the power supply disable circuit to monitor the amount of power that is being drawn by the powered peripheral 260. The power supply disable circuit may also be coupled to the power supply, and is able to disable the power supply when the power supplied to the powered USB port exceeds a threshold. In one example implementation the power supply disable circuit may be a current sensing network. In one example implementation, the threshold may be 100 VA of power supplied to the powered peripheral.

The power supply disconnect circuit 240 may be coupled to the power supply and to the powered USB port. When the power supply disable circuit fails and the power drawn from the powered USB port exceeds a threshold, the power supply disconnect circuit may cause the powered peripheral to be disconnected from the powered USB port. In other words, the power supply disconnect circuit is only activated when the power supply disable circuit fails, and even then only when the powered peripheral attempts to draw an amount of power that exceeds the threshold. The power supply disconnect circuit may be any type of non-adjustable, non-auto-reset, electromechanical device. In one example implementation, the power supply disconnect circuit may be a fuse.

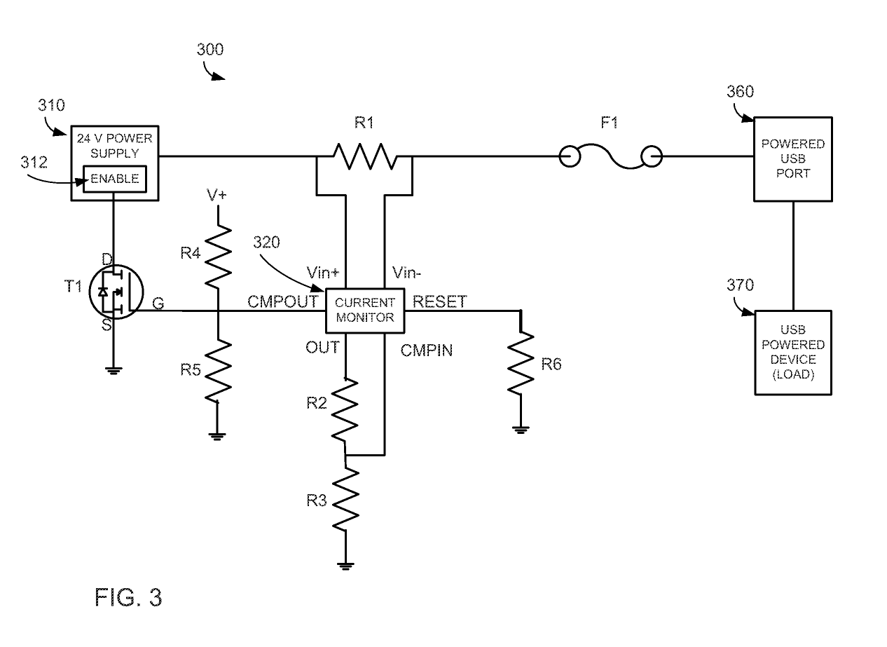

FIG. 3 is a schematic of an example implementation of circuits to implement the techniques described herein. Although an example implementation is shown, it should be understood that the circuits and techniques described herein are not limited to the example. Any circuits suitable to provide the same functionality as the example implementation are also suitable.

The circuit 300 may include a power supply 310. In one example implementation, the power supply may be a 24 V DC power supply. The power supply may include an enable input 312. When the enable input is asserted, the power supply may provide power at 24 V DC. When the enable input is not asserted, the power supply may discontinue providing power. The power supply may provide power to a powered USB port 360, through resistor R1 and fuse F1. Operation of these components is described below. The powered USB port may be coupled to a USB powered device, also referred to as a load 370. In other words, the power supply provides power to the load through the above mentioned components.

Circuit 300 may also include a current monitor 320. The current monitor may monitor the current flowing from the power supply to the load. In one example implantation, the current monitor may be a high side measurement current shunt monitor with comparator and reference, such as an INA201 provided by Texas Instruments™. The current monitor may provide an internal reference voltage that may be used to determine the amount of current being drawn by the load as will be described below. Although a specific device is being described, it should be understood that any current monitor circuit capable of monitoring current drawn and asserting/de-asserting a signal in response to the current being within/outside of a specified threshold may also be used.

The current monitor 320 may be coupled to both sides of resistor R1 through the Vin+ and Vin− inputs. These inputs of the current monitor may be internally connected to a comparator, which determines the voltage drop across R1. The result, or difference between Vin+ and Vin−, of this voltage drop are output on the OUT pin. The OUT pin may be tied to ground through resistors R2 and R3 which form a voltage divider. Selection of the values for R2 and R3 is described below. Voltage after the voltage drop caused by R2 may be coupled to the CMPIN input of the current monitor. The CMPIN input is internally connected to a comparator, which may compare the CMPIN voltage to an internal reference voltage. If CMPIN exceeds the internal reference voltage, the CMPOUT line may be asserted, whose operation will be described in further detail below. For the example circuit presented, the CMPOUT line is an active low signal, meaning that an assertion is coupling the line to ground, while de-assertion is sending the line to a higher voltage state.

The voltage drop across R1 when the circuit is operating at the threshold current at 24 V DC can be calculated by dividing the threshold current by the value of R1. If the voltage drop exceeds this value, then the load is drawing current in excess of the threshold. The value of resistors R2 and R3 may be selected such that when operating at the threshold current, the voltage drop across R2 is equal to the internal reference voltage. Thus the voltage present at the CMPIN input may be equal to the reference voltage. If the current exceeds the threshold value, the voltage drop across R1, as reflected by the CMPIN value determined by the voltage drop across R2 will exceed the internal reference voltage. As such, the CMPOUT line may be asserted.

The CMPOUT line may be coupled to the enable input of the power supply through transistor T1. When the CMPOUT line is asserted, which for purposes of this discussion means the CMPOUT line is grounded, the voltage supplied to the gate of transistor T1 is zero, thus causing T1 to remain off. As such, power supply 310 remains enabled. When the CMPOUT line is de-asserted, which in this case means decoupled from ground, the voltage at the gate of T1 is pulled high through R4 and R5. Thus, T1 is turns on, and couples the enable input of the power supply to ground. For purposes of this example implementation, coupling the enable input of the power supply to ground cases the power supply to cease providing power to the load. For the sake of completeness, in the example implementation described, the reset pin is tied to ground through resistor R6, which disables the latching functions of the current monitor, thus causing the CMPOUT line to directly track the current through R1 exceeding the threshold. Furthermore, for purposes of simplicity, supply and ground connections for the current monitor are omitted.

Fuse F1 may be coupled to resistor R1 on one side and the powered USB port on the other. If the current through fuse F1 exceeds the threshold, the fuse may blow and disconnect the power supply from the load. As mentioned above, the response time for the current sensing portion of the circuit 300 may be less than the response time of the fuse. Thus, in normal operation, any over current condition may be detected by the current sensing network and the power supply disabled before the fuse is blown.

In operation, circuit 300 provides a two level protection mechanism that is compliant with UL60950-1 ed.2. If the current provided to the load through resistor R1 exceeds a threshold, the current sensing network disables the power supply, preventing the load from drawing too much current. Thus item c) of the specification is satisfied. However, as mentioned above, compliance with UL60950-1 ed.2 means that protection is provided given a single failure of the current sensing network. One failure may be a short circuit across resistor R1, which essentially disables the current sensing network (because there is no longer a voltage drop across R1, the current sensing network would assume that no current is flowing, when in fact the actual current flowing cannot be determined). In such a failure case, the fuse still provides protection according to item d) of the specification. Thus, the requirements of UL60950-1 ed.2 may be met while not sacrificing product design and maintainability features that were described above.

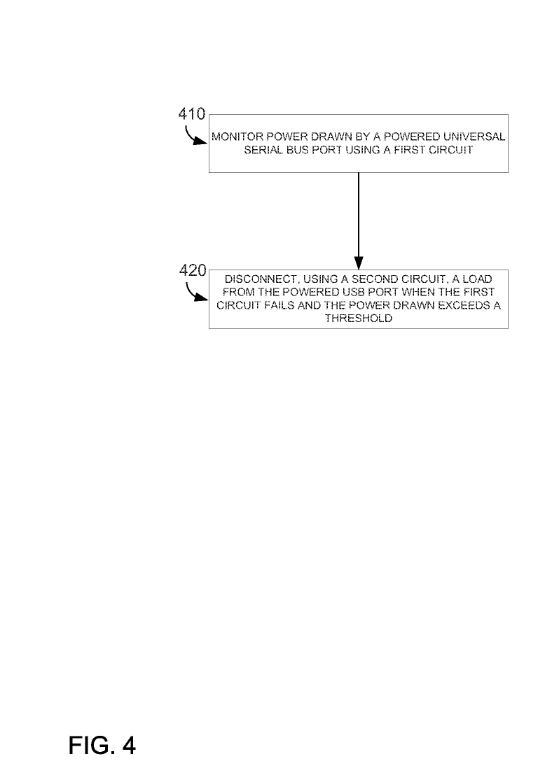

FIG. 4 is a example high level flow diagram according to the load power threshold techniques described herein. In block 410, the power drawn by a powered universal serial bus port may be monitored using a first circuit. In block 420, using a second circuit, a load may be disconnected from the powered USB port when the first circuit fails and the power drawn exceeds a threshold.

We claim:

1. A system comprising:
a power source, the power source including a power output and an enable input, the power source supplying power to the power output while the enable input is asserted;
a first circuit coupled to the power output to measure a current drawn by a load, the first circuit further to assert the enable input while the current drawn is less than a threshold, the first circuit having a first response time; and
a second circuit coupled to the load to disconnect the load from the power source when the current exceeds the threshold, the second circuit having a second response time.

2. The system of claim 1 wherein the second circuit is a non-resettable fuse.

3. The system of claim 1 wherein the first response time is less than the second response time.

4. The system of claim 1 wherein the first response time is less than 5 seconds.

5. The system of claim 1 wherein the second response time is less than 60 seconds.

6. The system of claim 1 wherein the power source is a 24 volt DC power source.

7. A retail point of sale system comprising:
a powered universal serial bus (USB) port;
a first circuit coupled to the powered USB port to disable a power supply supplying power to the powered USB port when the power supplied exceeds a threshold; and
a second circuit to disconnect a load from the powered USB port when the first circuit fails and power drawn from the powered USB port exceeds the threshold.

8. The system of claim 7 wherein the first circuit is a current sensing network.

9. The system of claim 7 wherein the second circuit is a fuse.

10. The system of claim 7 wherein the second circuit is a non-adjustable, non-auto-reset, electromechanical device.

11. The system of claim 7 wherein the threshold is 100 Volt-Amperes (VA).

12. The system of claim 7 wherein the powered USB port is a 24 volt DC port.

13. A method comprising:
monitoring the power drawn by a powered universal serial bus (USB) port using a first circuit;
disconnecting, using a second circuit, a load from the powered USB port when the first circuit fails and the power drawn exceeds a threshold.

14. The method of claim 13 further comprising:
disabling, using the first circuit, a power source supplying power to the powered USB port when the power drawn exceeds the threshold.

15. The method of claim 14 wherein the powered USB port supplies 24 volts DC and the threshold is 100 Volt-Amperes (VA).
